(19) United States
(12) Patent Application Publication
(10) Pub. No.: US 2006/0163280 A1
(43) Pub. Date: Jul. 27, 2006

(54) Dispensing tube opener

(75) Inventors: Brent W. Murray, Longmont, CO (US); Anthony F. Whitemiller, Boulder, CO (US)

Correspondence Address: THE LAW FIRM OF HARRIS & BURDICK;HAROLD BURDICK AND ROBERT HARRIS, 6676 GUNPARK DRIVE, SUITE E, BOULDER, CO, 80301, US

(73) Assignee: Accurate Concepts, Inc.

(21) Appl. No.: 11/041,133

(22) Filed: Jan. 24, 2005

(51) Int. Cl. B67D 5/00

(52) U.S. Cl. 222/81

(57) ABSTRACT

An opener is disclosed for accessing contents of a dispensing tube having a monolithic dispensing tip that requires cutting to allow dispensing of material from the tube. The opener includes a housing with first and second elongated passageways intersecting therein at an angle. The first passageway has a span selected to receive and stabilize a length of the dispensing tip at a cutting location, and a cutting utility is movably mounted in the other passageway with a cutting end thereof located adjacent to the intersection with the first passageway and a user contactable portion thereof extending from the housing. A locating collar (or collars) receivable at the first passageway is configured to accommodate different user selected cutting locations along the length of the dispensing tip without loss of stability. A return mechanism is maintained in the housing for returning the cutting utility to a position with the cutting end substantially withdrawn from the first passageway after a cut is made. A lance for puncturing a foil seal in the tube is pivotably mounted at one end of a channel at the housing exterior and is receivable in said channel when not in use.

### FIELD OF THE INVENTION

This invention relates to opening cylindrical tubes having a closed and sealed dispensing tip such as the type utilized for packaging and dispensing caulk or other sealants or adhesives, and, more particularly, relates to a cutter/opener for such tubes.

### BACKGROUND OF THE INVENTION

Sealants such as caulk and adhesives are commonly provided in and dispensed from cylindrical tubes having a monolithic tapering (elongated conical, for example) plastic dispensing tip that is closed at its outermost tapered end upon delivery to an end user. Such tubes also commonly include a plastic/foil seal at the interface between the tube and dispensing tip. The dispensing tip must be cut and the foil seal punctured before any product can be dispensed from the device (typically using a mechanical device that applies pressure at the back of the cylindrical tube opposite the tip, often referred to as a “caulk gun”).

For aesthetic reasons, application of caulking or other sealants at various surfaces (around masonry, plumbing fixtures, windows and the like) requires precision to provide a bead of material having consistent width and/or depth and without surface blemishes. A properly cut dispensing tip on a caulk tube, for example, is preferably cut at a 45° angle at a location along the tip selected to provide a predetermined opening diameter. The cut must be without burrs to avoid striations or changes in shape of the applied bead. The foil seal must then be punctured to allow dispensing of the material in the tube.

Heretofore, such cuts were most often accomplished utilizing various knives, utility knives for example. Obtaining the desired tube cut (at the proper angle, linearity and without burrs) using such tools is difficult at best, and thus the desired degree of perfection in the application of the material bead is compromised. Such operations utilizing a utility knife is also hazardous for the worker.

Dedicated cutting tools or cutting markers for such purposes have heretofore been suggested and/or utilized, and have often been deployed together with a caulking gun (see U.S. Pat. No. 4,328,910, Des.414,665, U.S. Pat. Nos. 4,158,914, 4,802,607, 6,056,156, 4,135,644and 4,493,437. Such heretofore suggested dispensing tube cutting tools, however, have not always improved user safety or provided for selected tube tip opening diameter, angle precision or consistency and smoothness of cuts. Moreover, some such tools are often bulky and inconvenient or difficult to use (particularly when made part of a caulking gun). Further improvements could thus still be utilized.

### SUMMARY OF THE INVENTION

This invention provides an opener for accessing contents of a dispensing tube having a monolithic dispensing tip that requires cutting to allow dispensing of material from the tube. The opener is user safe and allows for user selected tube tip opening diameter, cut angle precision and cut consistency and smoothness. The opener is compact (fitting in the user's palm and storing readily in a pocket or pouch) and thus more convenient and simple to use.

The opener of this invention includes a housing with first and second elongated passageways intersecting therein at an angle. The first passageway has a span selected to receive and stabilize a length of the dispensing tip at a cutting location. A cutting utility is mounted for movement in the other passageway and has a cutting end preferably maintained substantially entirely within the housing, a user contactable portion thereof extending from the housing. The cutting end is located adjacent to the intersection with the first passageway, the user contactable portion being engageable by a user to move the cutting end across the first passageway.

The housing includes a matable structure adjacent to a first end of the first passageway. A locating collar (or collars) is receivable at the first end of the first passageway, a mating structure thereof engageable at the matable structure of the housing and configured for stabilization of the dispensing tip received in the first passageway at different user selected cutting locations along its length. A mechanism is maintained in the housing for returning the cutting utility to a position with the cutting end substantially withdrawn from the first passageway after a cut is made.

It is therefore an object of this invention to provide an improved opener for accessing contents of a dispensing tube having a monolithic dispensing tip that requires cutting to allow dispensing of material from the tube

It is another object of this invention to provide an opener for accessing contents of a dispensing tube that is user safe and allows for user selected tube tip opening diameter, cut angle precision and cut consistency and smoothness.

It is still another object of this invention to provide an opener for accessing contents of a dispensing tube that fits into a user's palm and stores readily in a pocket or pouch.

It is yet another object of this invention to provide an opener for accessing contents of a dispensing tube that is convenient and simple to implement.

It is another object of this invention to an opener for accessing contents of a dispensing tube having a monolithic dispensing tip that requires cutting to allow dispensing of material from the tube, the opener including a housing defining first and second elongated passageways intersecting at an angle in the housing, the first passageway having a span to receive a length of the dispensing tip and stabilize the dispensing tip at a cutting location when received therein, and a cutting utility mounted for linear movement in the second passageway of the housing and having a cutting end maintained substantially entirely within the housing and a user contactable portion extending from the housing.

It is still another object of this invention to provide an opener for accessing contents of a dispensing tube having a monolithic dispensing tip that requires cutting to allow dispensing of material from the tube, the opener including a housing defining first and second elongated passageways intersecting at an angle in the housing, the first passageway having a span to receive a length of the dispensing tip between first and second ends of the first passageway and configured for stabilizing the dispensing tip at a selected relative cutting location when received therein, the housing including a matable part adjacent to the first end of the first passageway, a cutting utility mounted for movement at the second passageway of the housing and having a cutting end maintained substantially entirely within the housing and a user contactable portion extending from the housing, and locating means receivable at the first end of the first passageway and having a mating part engageable at the matable part of the housing for stabilization of the dispensing tip received in the first passageway at different user selected cutting locations along the length of the dispensing tip.

It is yet another object of this invention to provide an opener for accessing contents of a dispensing tube having a monolithic dispensing tip that requires cutting to allow dispensing of material from the tube, the opener including a housing defining first and second elongated passageways meeting at an intersection in the housing, the first passageway having a span to receive a length of the dispensing tip and stabilize the dispensing tip at a selected cutting location when received therein, a cutting utility mounted for linear movement in the second passageway of the housing and having a cutting end maintained entirely within the housing adjacent to the intersection with the first passageway and a user contactable portion extending from the housing and engageable by a user to move the cutting end across the first passageway, and a return mechanism maintained in the housing and operatively associated with the cutting utility for returning the cutting utility to a position with the cutting end substantially withdrawn from the first passageway.

With these and other objects in view, which will become apparent to one skilled in the art as the description proceeds, this invention resides in the novel construction, combination, and arrangement of parts substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to the best mode so far devised for the practical application of the principles thereof, and in which:

FIG. 1 is a perspective view of a first embodiment of the dispensing tube opener of this invention;

FIG. 2 is an exploded perspective view of the opener of FIG. 1;

FIG. 3 is a sectional view of the opener of FIG. 1 illustrating operation of the opener to cut a dispensing tip of a cylindrical dispensing tube;

FIG. 4 is a perspective view of the depth adjustment collar utilized with the opener of FIG. 1;

FIG. 5 is an end view illustrating a second embodiment of the opener of this invention employing plural collars each configured to achieve a different dispensing opening diameter; and

FIG. 6 is an end view of still another embodiment of the opener of this invention employing a threaded design at the collar interface for selective dispensing opening diameter.

### DESCRIPTION OF THE INVENTION

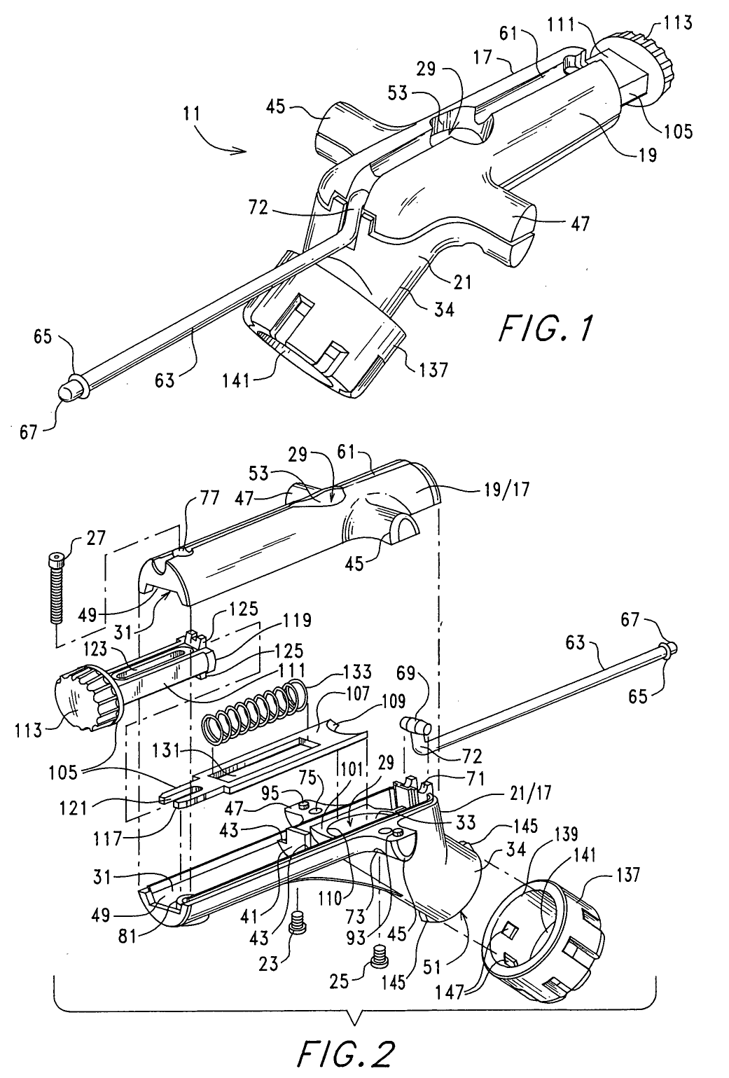

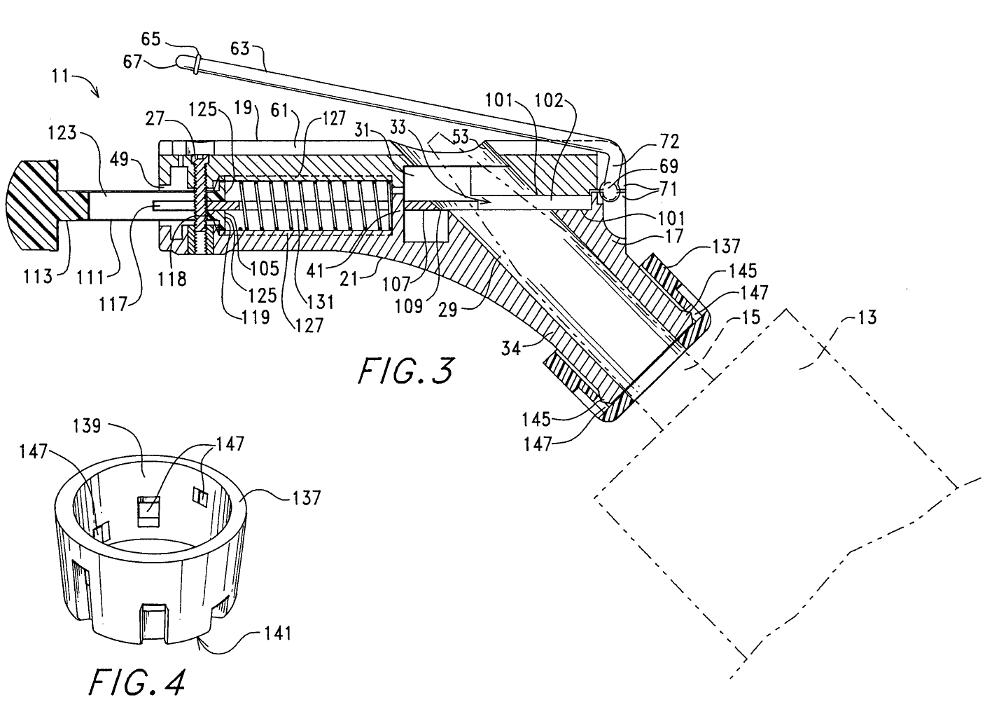

Referring to FIGS. 1 through 3, a first embodiment 11 of the opener of this invention is illustrated. The opener is configured for accessing the contents of a dispensing tube 13 of the type having a monolithic dispensing tip 15 that requires cutting to allow dispensing of material from the tube (see FIG. 3). Such tubes, common in the trades pertaining to caulking and sealing, also typically have an inner foil seal that must also be punctured in order of material to be dispensed.

Opener 11 includes a housing 17 formed from upper and lower housing sections 19 and 21, respectively, the housing sections secured by threaded connectors 23, 25 and 27. First and second elongated passageways 29 and 31, respectively, are defined through housing 17 by the interior configurations of housing sections 19 and 21 and meet at intersection 33 within the housing (see especially FIG. 3). Housing section 21 includes angled portion 34 defining the greater part of passageway 29. Passageways 29 and 31 intersect at an angle at intersection 33, the angle selected to accommodate angled cutting of dispensing tip 15 (in the range of from 15° to 80° relative to the axis defining dispensing tip length, and preferably 45° as shown herein, though other models can be configured for different cutting angles).

Length of span of passageway 29 is selected to receive a selected length of dispensing tip 15 therethrough and stabilize the dispensing tip at a cutting location at intersection 33. Housing section 21 includes abutment 41 having guides 43 positioned laterally thereof (similar guides are correspondingly positioned at housing section 19, but without a corresponding abutment). Both housing sections 19 and 21 are configured to provide finger engageable housing extensions 45 and 47 at each side of housing 17 which are engageable by a user's finger during use as will become apparent. Opening 49 from housing 17 is formed at one end of passageway 31 by the configuration of housing sections 19 and 21 (the other end of passageway 31 terminating at or near intersection 33). Openings 51 and 53 from housing 17 (at each end of passageway 29) allow movement of dispensing tip 15 through the passageway as shown in FIG. 3.

Channel 61 along the length of the exterior of housing section 19 is provided for storage of lance 63 when lance 63 is not in use. Lance 63 is provided for puncturing the foil seal internal of may dispensing tubes, and includes an enlarged collar 65 at puncture end 67 thereof to enhance puncture efficacy. Lance 63 includes integral pivot 69 held at hub structure 71 formed by structure at each of housing sections 19 and 21. Leg 71 of lance 63 accommodates pivoting of lance 63 into and out of channel 61.

As shown in FIG. 2, openings 73, 75 and 77 are provided in housing 17 to receive and retain the threaded connectors. Connectors 23 and 25 are received by threaded openings at extensions 47 and 45, respectively, of housing section 19 (not shown), and connector 27 is received by threaded post 81 at housing section 21. Pins 93 and 95 at extensions 45 and 47 of housing section 21 are receivable in corresponding openings at extensions 45 and 47 of housing section 19 to aid alignment retention between housing sections. Guide surface 101 is defined at housing section 21 adjacent to intersection 33 (a corresponding guide surface is defined at housing section 19 adjacent to opening 53). For reasons that will become apparent as this description proceeds, the various guides and guide surfaces at housing sections 19 and 21 are dimensioned and located so that gap 102 is defined between the guides and guide surfaces at housing section 19 and the corresponding ones of the guides and guide surface at housing section 21 (as shown between guide surfaces 101 in FIG. 3, it being understood that a similar gaps exist between corresponding guides 43).

Cutting utility 105 is mounted for linear movement in at passageway 31 of housing 17, and includes slide 107 having a cutting end 109 (preferably having a concave cutting surface thereat, the concavity substantially matching arc 110 defined by the entry at intersection 33 of passageway 29) thereat and plunger 111 having a user contactable portion 113 thereat. Cutting end 109 is maintained entirely within housing 17 thus enhancing user safety. One end of plunger 111 including portion 113 extends through opening 49 from said housing 17. Plunger 111 and slide 107 are friction fit to one another with spread fork 117 receivable into slot 118 at end 119 of plunger 111. Slot 121 at fork 117 and slot 123 in plunger 111 are provided to receive connector 27 therethrough to further secure plunger 111 within the opener and define the extent of travel of utility 105 in passageway 31 (see FIG. 3). End guides 125 of plunger 111 are guided on tracks 127 of adjacent passageway 31 at each of housing sections 19 and 21 (see FIG. 3).

Slide 107 of cutting utility 105 has slot 131 therein receivable over abutment 41. Slide 107 is smoothly transported between corresponding guides 43 and guide surfaces 101 at housing sections 19 and 21 in gap 102 thus maintaining, in cooperation with the stable location of fork 117 in slot 118 of plunger 111, alignment of slide 107 and thus the cutting surface of cutting end 109 thereof. Return spring 133 is maintained in slot 131 with one end thereof contacting abutment 41 and the other end contacting the end of slot 131 (other means of biasing cutting utility 105 could be utilized at would be apparent). In use, this arrangement assures return of cutting utility 105 to a position with plunger 111 fully extended from housing 17 and with cutting end 109 substantially withdrawn from passageway 29 after movement by a user to cut a dispensing tip (with the user engaging contactable portion 113 to move cutting end 109 across passageway 29 having a dispensing tip selectively located thereat).

Turning now to FIG. 4, locating collar 137 is provided for user adjustment of the effective length of passageway 29 thereby accommodating stabilization of dispensing tip 15 at different user selected cutting locations along the length of the dispensing tip. Collar 137 includes mounting opening 139 and dispensing tip receiving opening 141 and is mountable at mounting opening 139 at the end of angled portion 34 of housing section 21. Housing section 21 includes at least one said protuberance 145 (preferably two) at the end thereof. Plural mating notches 147 (preferably three for each provided protuberance 145) are arrayed at an interior portion of collar 137 at different depths relative to receiving opening 141.

Engagement (as shown in FIG. 3) of protuberances 145 with opposing selected notches 147 secured collar 137 a selected distance from the intersection 33. By twisting collar 137 to achieve engagement of a different pair of notches 147 at protuberances 145 (the different pair at a different depth relative to receiving opening 141) a different distance is achieved to intersection 33, thus effectively adjusting the length of passageway 29 and defining a new cutting location along the length of an inserted dispensing tip 15 (for tips of the same size). The three notch pair depth locations preferred, when used in association with commonly sized dispensing tube tips, correspond to a dispensing tip opening size after cutting of 0.5″, 0.25″ or 0.125″ depending upon notch 147 pair selection.

It should be realized that the use of protuberances and notches as shown could be reversed (with a notch of notches located at housing 17 and a protuberance of protuberances located at collar 137. Moreover, as an alternative to collars having multiple, different depth notches, plural collars could be provided each one having a single notch pair at a different depth with respect to others of the plural collars.

A first alternative embodiment of this invention is illustrated by FIG. 5 wherein user adjustment of cross-section of at least a segment of passageway 29 to accommodate different user selected cutting locations is accomplished by providing plural locating collars 151, 153 and 155 (for example) each having mounting opening 157 and a dispensing tip receiving opening 159 and each separately mountable at mounting opening 157 at the end of angled portion 34 of housing section 21. As before housing section 21 includes at least one said protuberance 145 at the end thereof. An equal number of notches 161 (equal in number to protuberance 145 are provided at each collar for securement of the collars on the end of angled portion 34 engaging protuberance 145. In each of collars 151, 153, and 157 one of mounting opening 157 or receiving opening 159 has a different selected internal diameter relative to the other of said plural collars.

This means limits extent to which a tapered dispensing tube tip 15 is allowed entry into passageway 39 (different amounts for different ones of the collars) thereby defining different cutting locations along the length of an inserted dispensing tip 15 (for tips of the same size) depending on the collar selected. The three collars preferred, when used in association with commonly sized dispensing tube tips, have internal diameters corresponding to a dispensing tip opening size after cutting of approximately 0.375″, 0.25″ or 0.125″ depending upon the collar selected.

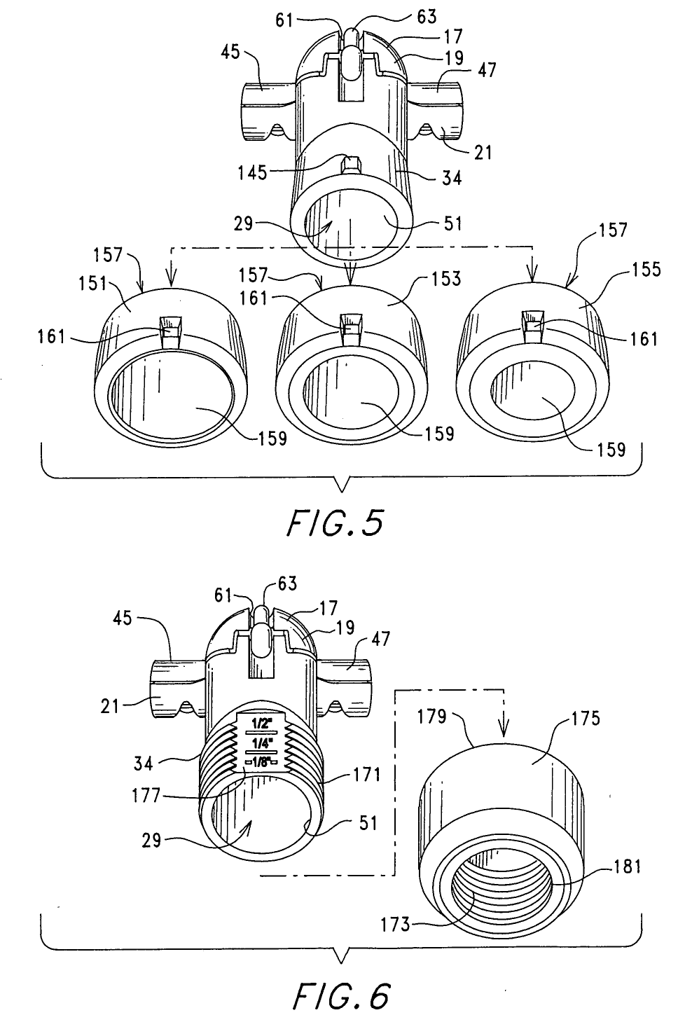

A second alternative embodiment of this invention is illustrated by FIG. 6 wherein user adjustment of the effective length of passageway 29 to accommodate different user selected cutting locations is accomplished by providing a threaded portion 171 at the end of angled portion 34 of housing section 21 for engaging mating threaded section 173 at locating collar 175 (the internal and external thread configurations could be reversed). Indicator/gauge 177 is located at threaded portion 171 and is calibrated to show the different positions a user should use when threading collar 175 onto threaded portion 171 to locate end 179 (adjacent to the mounting opening thereof) of collar 175 to achieve a selected dispensing tip opening size after cutting (0.5″, 0.25″ or 0.125″, for example).

Thus by threading collar 175 to move the collar up or down relative to indicator 177 a different distance is achieved to between intersection 33 and dispensing tip receiving opening 159 181, thus effectively adjusting the length of passageway 29 and defining a new cutting location along the length of an inserted dispensing tip 15 (for tips of the same size).

The openers of this invention of preferably of a size selected so that contactable portion 113 is engageable in a hand of the user and moveable thereby in cooperation with fingers of the same hand engaging housing extensions 45 and/or 47, thereby to effect cutting movement of cutting end 109 of cutting utility 105. The preferred dimensions are thus about 5″ long and 2″ or less wide (at angled portion across finger grip extensions 45 to 47), with housing 17 at passageway 31 being less than about 1″ in diameter,

As may be appreciated, the angle of cut made be the openers of this invention depends upon the angle of intersection of elongated passageways 29 and 31. Thus various models of the openers configured to accommodate different cutting angles could be provided to allow cut angles (from 15° to 80°, for example). Alternatively, an opener could be configured having two housings each housing a different one of the passageways and pivotably connected with each other, and indexed, at the passageways' intersection for user setting of angle of cut.

The openers of this invention can be variously shaped and may have many parts unitarily cast and assembled. the openers may be made of selected materials including various metals, plastics, composites, or combinations thereof.

What is claimed is:

1. An opener for accessing contents of a dispensing tube having a monolithic dispensing tip that requires cutting to allow dispensing of material from the tube, said opener comprising:
a housing defining first and second elongated passageways intersecting at an angle in said housing, said first passageway having a span to receive a length of the dispensing tip and stabilize the dispensing tip at a cutting location when received therein; and
a cutting utility mounted for linear movement in said second passageway of said housing and having a cutting end maintained substantially entirely within said housing and a user contactable portion extending from said housing.

2. The opener of claim 1 further comprising means for one of changing cross-section of at least a segment of said first passageway or adjusting length of said first passageway thereby accommodating stabilization of the dispensing tip at different user selected cutting locations along the length of the dispensing tip.

3. The opener of claim 1 wherein said second passageway of said housing is linear and includes one end opening through said housing and an opposite end terminating at or near said first passageway.

4. The opener of claim 3 wherein said user contactable portion of said cutting utility extends through said one end of said second passageway and wherein said cutting end of said cutting utility is movable across said first passageway by user manipulation of said contactable portion of said cutting utility.

5. Claim 1 wherein the dispensing tube includes an inner foil seal, said opener further comprising a lance mounted at said housing for puncturing the foil seal.

6. The opener of claim 1 wherein said first passageway includes opposite ends each opening through said housing, said intersecting angle of said first and second passageways selected to provide a cutting angle relative to a dispensing tip received in said first passageway of about 45°.

7. An opener for accessing contents of a dispensing tube having a monolithic dispensing tip that requires cutting to allow dispensing of material from the tube, said opener comprising:
a housing defining first and second elongated passageways intersecting at an angle in said housing, said first passageway having a span to receive a length of the dispensing tip between first and second ends of said first passageway and configured for stabilizing the dispensing tip at a selected relative cutting location when received therein, said housing including a matable part adjacent to said first end of said first passageway;
a cutting utility mounted for movement at said second passageway of said housing and having a cutting end maintained substantially entirely within said housing and a user contactable portion extending from said housing; and
locating means receivable at said first end of said first passageway and having a mating part engageable at said matable part of said housing for stabilization of the dispensing tip received in said first passageway at different user selected cutting locations along the length of the dispensing tip.

8. The opener of claim 7 wherein said matable part of said housing is at least one of a single or plural protuberance or a single or plural notches and wherein said mating part of said locating means is one of a single or plural protuberance or a single or plural notches.

9. The opener of claim 8 wherein said matable part includes at least one said protuberance, said locating means comprising a collar having a mounting opening and a dispensing tip receiving opening and mountable at said mounting opening on said housing adjacent to said first end of said first passageway, said mating part including plural said notches arrayed at an interior portion of said collar, each of said notches at different depths relative to said receiving opening.

10. The opener of claim 8 wherein said matable part includes at least one said protuberance, said locating means comprising plural collars each having a mounting opening and a dispensing tip receiving opening and each separately mountable at said mounting opening on said housing adjacent to said first end of said first passageway, one of said mounting opening or said receiving opening of each of said plural collars having a different selected diameter relative to the other of said plural collars.

11. The opener of claim 7 wherein said matable part of said housing is a threaded section and wherein said mating part of said locating means is a threaded portion engageable with said threaded section of said housing.

12. The opener of claim 11 wherein said threaded section of said housing includes an indicator thereat showing different positions for said locating means in order to achieve different dispensing tip opening diameters.

13. The opener of claim 7 wherein said housing includes finger engageable extensions.

14. The opener of claim 13 wherein said housing is of a size so that, for movement of said user contactable portion of said cutting utility to effect cutting movement of said cutting end of said cutting utility, said contactable portion is engageable in a hand of the user and moveable thereby in cooperation with fingers of the hand engaging said housing extensions.

15. An opener for accessing contents of a dispensing tube having a monolithic dispensing tip that requires cutting to allow dispensing of material from the tube, said opener comprising:
a housing defining first and second elongated passageways meeting at an intersection in said housing, said first passageway having a span to receive a length of the dispensing tip and stabilize the dispensing tip at a selected cutting location when received therein;
a cutting utility mounted for linear movement in said second passageway of said housing and having a cutting end maintained entirely within said housing adjacent to said intersection with said first passageway and a user contactable portion extending from said housing and engageable by a user to move said cutting end across said first passageway; and
a return mechanism maintained in said housing and operatively associated with said cutting utility for returning said cutting utility to a position with said cutting end substantially withdrawn from said first passageway.

16. The opener of claim 15 wherein said cutting end of said cutting utility includes a concave cutting edge.

17. The opener of claim 15 wherein said return mechanism includes a spring mounted between an abutment within said housing and a structure of said cutting utility.

18. The opener of claim 15 wherein said cutting utility includes a plunger having said user contactable portion thereat and a slide having said cutting end thereat and receivable at said plunger at an opposite end of said slide, said housing including guiding structure at said second passageway for slidably guiding said slide of said cutting utility.

19. The opener of claim 18 wherein said slide includes a slot therethrough and wherein said return mechanism is maintained in said slot.

20. The opener of claim 15 wherein said housing includes a channel defined at an exterior portion thereof, said opener further comprising a lance pivotably mounted adjacent to one end of said channel and receivable in said channel when not in use.
